(19) United States
(12) Patent Application Publication
(10) Pub. No.: US 2009/0083114 A1
(43) Pub. Date: Mar. 26, 2009

(54) APPARATUS FOR DIARIZING JANITORIAL SERVICES DURING PATROL

(75) Inventor: Anthony M. Talarico, Ontario (CA)

Correspondence Address: BRINKS HOFER GILSON & LIONE, P.O. BOX 10395, CHICAGO, IL, 60610, US

(73) Assignee: Hurley Corporation, Toronto (CA)

(21) Appl. No.: 12/236,724

(22) Filed: Sep. 24, 2008

Related U.S. Application Data
(63) Continuation of application No. 10/668,446, filed on Sep. 23, 2003, now abandoned.
(60) Provisional application No. 60/466,952, filed on Apr. 30, 2003.

(51) Int. Cl. G06Q 50/00; G06Q 10/00

(52) U.S. Cl. 705/9

(57) ABSTRACT

The invention provides an apparatus for diarizing the performance of janitorial services during a patrol. The apparatus can be in a personal digital assistant format (“PDA”) that includes one or more built-in peripherals, such as a bar-code scanner. The bar-code scanner is used to scan bar codes that are applied at various locations throughout a facility. The bar codes identify individual locations in the facility that are to be cleaned as part of a janitorial patrol. The PDA is further operable to allow the janitor or cleaner to add enter electronic comments about one or more particular cleaning tasks that are performed at the location respective to each bar code. Other functions are also included in the PDA.

### PRIORITY CLAIM

The present application claims priority from U.S. 60/466,952, filed Apr. 30, 2003, the contents of which are incorporated herein by reference.

### FIELD OF THE INVENTION

The present invention relates generally to janitorial services, and more particularly relates to an apparatus for the diarizing the performance of janitorial services during janitorial patrols.

### BACKGROUND OF THE INVENTION

Janitorial services need to be provided in virtually all public facilities, particularly where there are public restroom facilities. Cleanliness and sanitation are important for the health and comfort of patrons. Accordingly, it is well known to provide regular, scheduled cleaning of such public facilities. The task of scheduling can be relatively straightforward or exceedingly complex, depending on the size of the facilities, the number of patrons who use the facilities, and the frequency with which the facilities are used. Thus, the proverbial small bistro with a single restroom may only need one or two cleanings a day, whereas a major international airport will have dozens of restrooms, eating facilities, hallways, waiting lounges that may need require scheduled cleanings several times a day, and over fairly regular intervals over any given twenty-four hour period. A further complication with large facilities is the management of the several hundred cleaning staff that are responsible for all of the scheduled cleanings. Still further complexity is added when those cleaning staff are not directly employed by the facility, but are employed by a cleaning services company that is contracted to provide such services to the facility.

The diarizing of the performance of janitorial services is also an important aspect of the provision of such services. While a cleaning schedule may be established and various cleaning staff assigned, such a schedule will be meaningless if it is not actually performed, and it is therefore also known to diarize the actual performance of cleaning services. Again, where such services are performed by a cleaning services company under contract, then the facility will typically require a diary or record proving that the services are actually being performed. Additionally, such diaries may be relevant in any lawsuit involving allegations that a facility's lack of cleanliness lead to personal injury—e.g. a slip and fall on a puddle of water.

Typically, the diarizing is done using pen and paper. It is very common to provide an sheet of paper on a clipboard which is carried by the janitor as they move throughout the facility during their cleaning patrol. The sheet of paper is updated by a cleaner once a particular area of that facility has been cleaned. The sheet may also include room for other information, such as notes about any items that may required repair or replacement in the area being cleaned.

This manual system presents a number of disadvantages. First, the cleaner must take additional time out of their cleaning schedule to complete the form. Further, there is typically no convenient surface in the facility to complete the form, which may therefore force the cleaner to carry a clipboard with him or her, thereby further burdening the cleaner with extra equipment. Additionally, once the sheet is completely filled, the cleaner may have to carry their own blank sheets. Still a further disadvantage is the need for someone to collect the sheets on a periodic basis and, if reports are to be provided, the data on each sheet needs to be tabulated and entered into a computer, leading to extra labour and a delay between the time the service was performed and the availability of a report to the facility verifying that such services were performed. An additional disadvantage is that the cleaner's handwriting may not be legible, or the spaces provided on the sheet to small, so patrons do not get the benefit of seeing when the facility was last cleaned in a convenient manner. Furthermore, it is often the case that cleaning staff's may represent a diverse range of cultural backgrounds and first languages, making the explanation of how the sheets are to be completed a difficult task. Still further disadvantages to the current diarizing system will occur to those of skill in the art.

### SUMMARY OF THE INVENTION

It is therefore an object of the invention to provide a novel apparatus for diarizing janitorial services during patrol that obviates or mitigates at least one of the above-identified disadvantages of the prior art.

An aspect of the present provides an apparatus for diarizing janitorial services during a cleaning patrol comprising: an outer casing that frames a display and a plurality of keys, a docking port, a barcode reader. Computing hardware interconnecting the display, the keys, the docking port and the barcode reader. The barcode reader is operable to receive barcode scans representative of at least one cleaning zone in a facility and bar code scans representative of at least one task to be performed in the at least one cleaning zone.

Another aspect of provides a portable computer-based method of diarizing the performance of janitorial services comprising the steps of:
i. determining a zone of a facility for cleaning;
ii. presenting the determined zone to a user;
iii. waiting for a scan of a barcode that matches with a barcode affixed to the determined zone;
iv. determining a task to be performed;
v. presenting the task to the user;
vi. waiting for a scan of a barcode on a task list that matches with a barcode respective to the task;
vii. repeating steps iv-vi until all tasks in a zone have been performed; and,
viii. repeating steps i-vii until all zones have been cleaned.

The computer-based method of diarizing the performance of janitorial services can include the additional steps of:

recording times when the barcode scans occur; and

uploading the recorded times to a host computer.

### BRIEF DESCRIPTION OF THE DRAWINGS

Embodiments of the invention will now be discussed, by way of example only, with reference to the attached Figures, in which:

FIG. 1 is a floorplan of an exemplary facility to which embodiments of the present invention can be applied;

FIG. 2 is a doorway entering one of the zone in the facility of FIG. 1;

FIG. 3 is a portable computing device in accordance with an embodiment of the invention;

FIG. 4 is a task list in the form of a plurality of cards in accordance with another embodiment of the invention;

FIG. 5 is a flowchart depicting a method of diarizing janitorial services in accordance with another embodiment of the invention;

FIG. 6 is shows a janitor using the device of FIG. 3 to scan a barcode associated with the zone;

FIG. 7 shows the device of FIG. 3 to scan the task list;

FIG. 8 shows the device of FIG. 3 being docked to a computer for uploading;

FIG. 9 is a portable computing device in accordance with another embodiment of the invention; and,

FIG. 10 is a portable computing device in accordance with another embodiment of the invention.

### DETAILED DESCRIPTION OF THE INVENTION

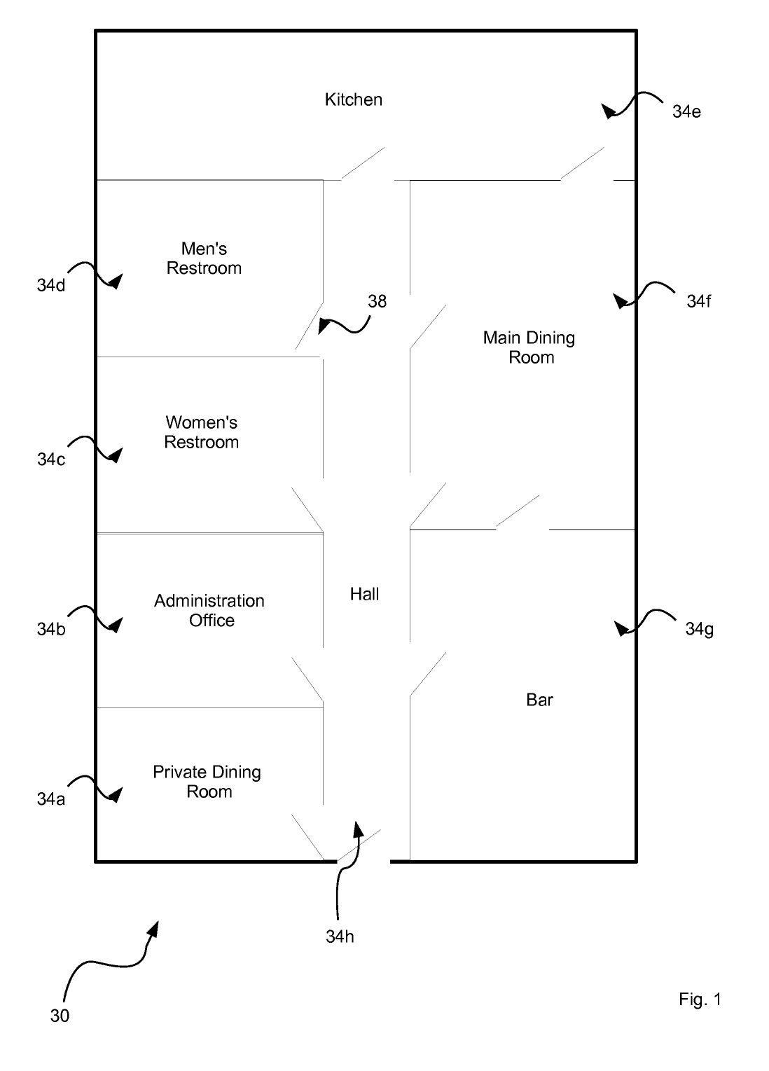

Referring now to FIG. 1, a facility to which embodiments of the present invention are applicable is indicated generally at 30. Facility 30 in the present embodiment is a restaurant, however, other facilities to which the present invention is applicable include airports, bus stations, railway stations, malls, office towers, office complexes, schools, and such other institutions where patrols of janitorial or cleaning services may be performed.

As shown in FIG. 1, facility 30 includes a number of cleaning zones 34. Table I shows the specific cleaning zones 34 of facility 30.

TABLE I

| Reference Number | Cleaning Zone Description |
|---|---|
| 34a | Private Dining Room |
| 34b | Administration Office |
| 34c | Women's Restroom |
| 34d | Men's Restroom |
| 34e | Kitchen |
| 34f | Main Dining Room |
| 34g | Bar |
| 34h | Hall |

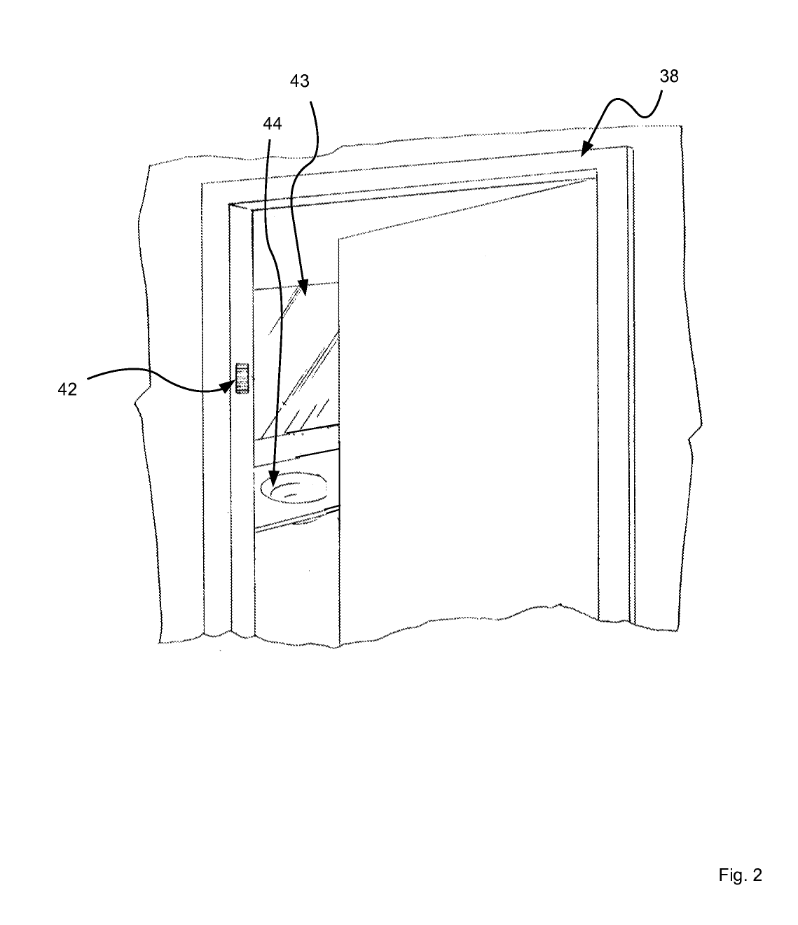

As can be seen in FIG. 1, a plurality of doors connect the various zones 34 of facility 30. In particular, the door identified at reference numeral 38 in FIG. 1 connects hall 34h with men's restroom 34d. Referring now to FIG. 2, door 38 is shown in greater detail. Door 38 in FIG. 2 is shown from the perspective of a person entering men's restroom 34d from hall 34h. As can be seen through door 38, there are a set of mirrors 43 and a sink 44 within men's restroom 34d. Affixed to the interior frame of door 38 is a barcode 42. Barcode 42 contains machine readable indicia that uniquely identifies men's restroom 34d. Thus, while not shown in the figures, each zone 34 of facility 30 has its own barcode that uniquely identifies that particular zone 34 within facility 30.

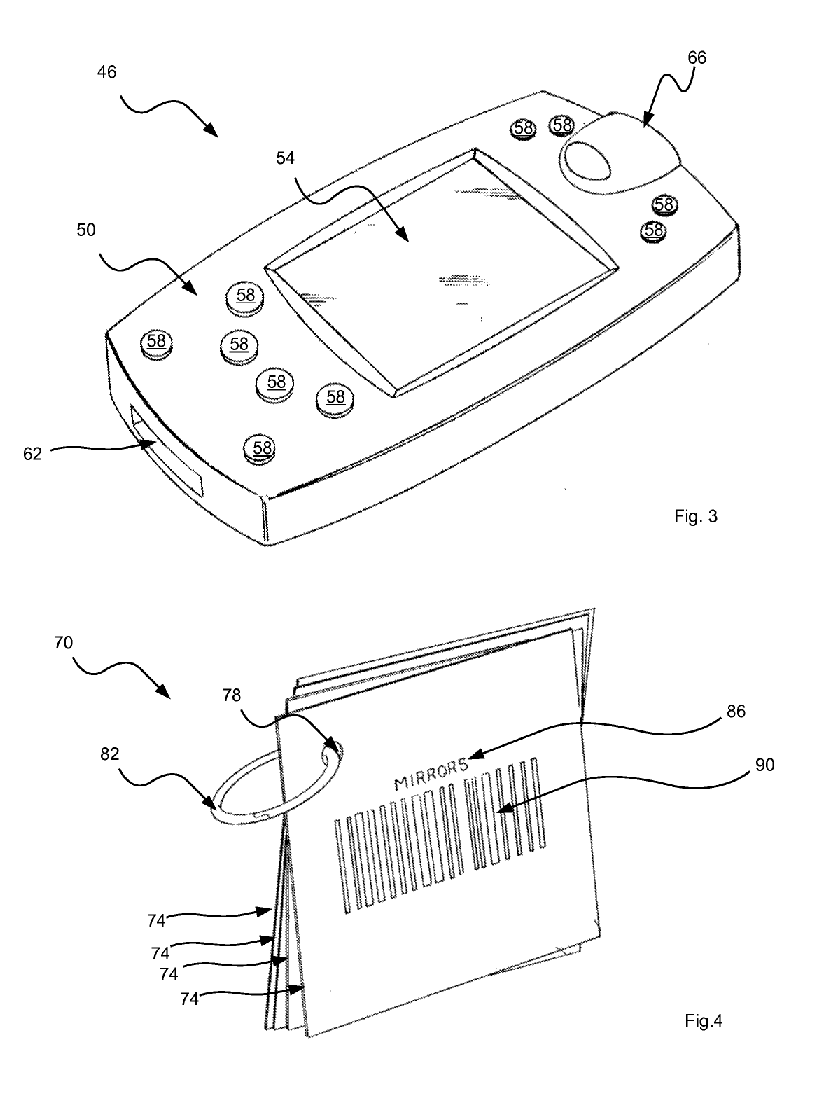

Referring now to FIG. 3, a portable computing device (“PCD”) in accordance with another embodiment of the invention is indicated generally at 46. PCD 46 has a form-factor suitable for handheld carrying and operation by a janitor. PCD 46 is characterized by a ruggedized clam-shell type outer casing 50 that has a number of openings that frame a display 54 and a plurality of keys 58. One end of PCD 46 includes a docking port 62, while the other end of PCD 46 includes a barcode reader 66. The hardware functionality of PCD 46 can be built from custom components, or it can be obtained from a manufacturer such as Symbol Technologies, Inc., Symbol Technologies—Corporate Headquarters, One Symbol Plaza, Holtsville, N.Y. 11742-1300, United States. An example of suitable equipment that includes desired hardware components of PCDs include SPT 1700 Pocketable Computers, made by Symbol Technologies, Inc., and which are based on the Palm® computing platform.

Whichever form-factor is chosen for PCD 46, it is presently preferred that PCD 46 be carriable by a janitor, in a carrying holster either worn by the janitor or attached to the janitor's cleaning cart. By pushing an appropriate key 58 to activate barcode reader 66, PCD is thus operable to read and recognize barcode 42 and other barcodes distributed throughout facility 30 and as are associated with various zones 34. Further details about the hardware and software functionality of PCD 46 will be discussed in greater detail below.

Referring now to FIG. 4, a machine readable task list in accordance with another embodiment of the invention is indicated generally at 70. In a present embodiment, task list 70 includes a plurality of laminated cards 74. Each card 74 is substantially the same size and has a small hole 78 punched in one corner. A releasable ring 82, such as a key ring, is passed through each hole and thereby holds cards 74 together. In this format, cards 74 can be conveniently flipped along ring 82, thereby allowing the user to view each card 74. Each card 74 includes a text and/or pictorial description 86 of a particular task that is to be performed as part of the cleaning patrol through facility 30. In addition, each card includes a barcode 90 corresponding to the description 86. In the example shown in FIG. 4, the top facing card 74 includes the description 86 in text form as “Mirrors”, and the barcode 90 underneath the text “Mirrors” includes a barcode that is also representative thereof. Barcode 90 may thus be structured as ASCII text which spells the word “Mirrors”, or as a unique number that corresponds in a table to the term “Mirrors”, as desired. While task list 70 is shown as a plurality of cards 74, it is to be understood that task list 70 can be presented in other formats. For example, multiple tasks 70 can be put on each card, making the card 74 larger, as needed. A convenient format for list 70, however, is presented in FIG. 4 as it allows the janitor to clip ring 82 to his or her belt, and/or to his or her cart.

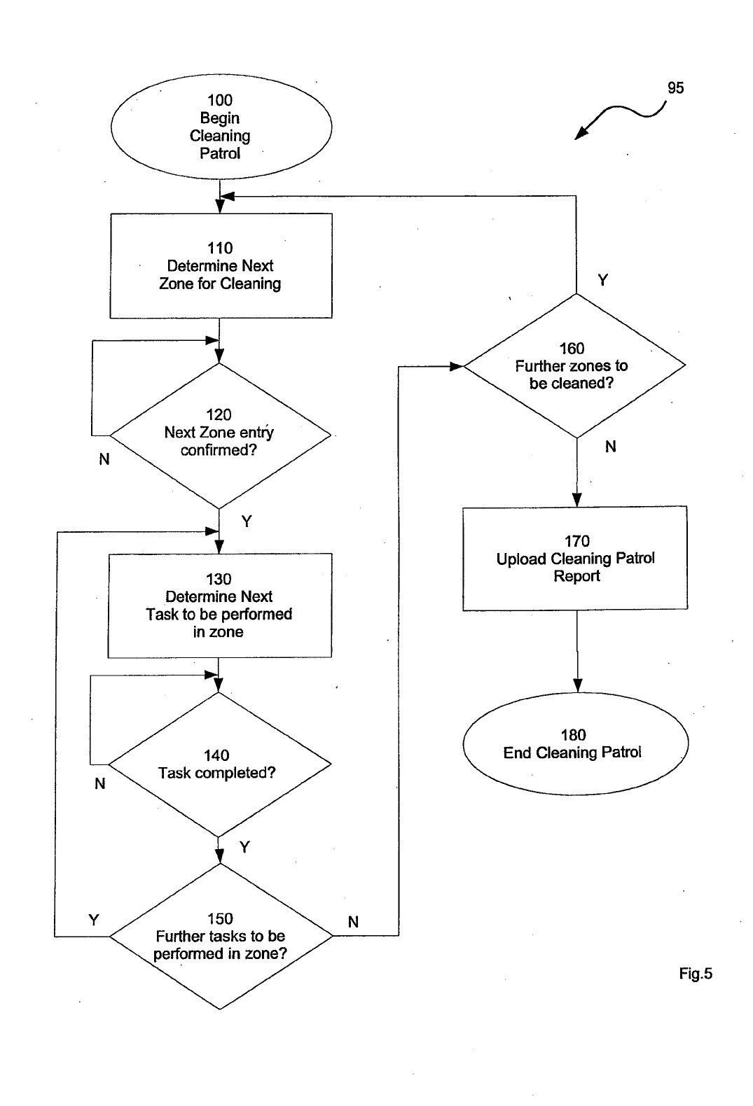

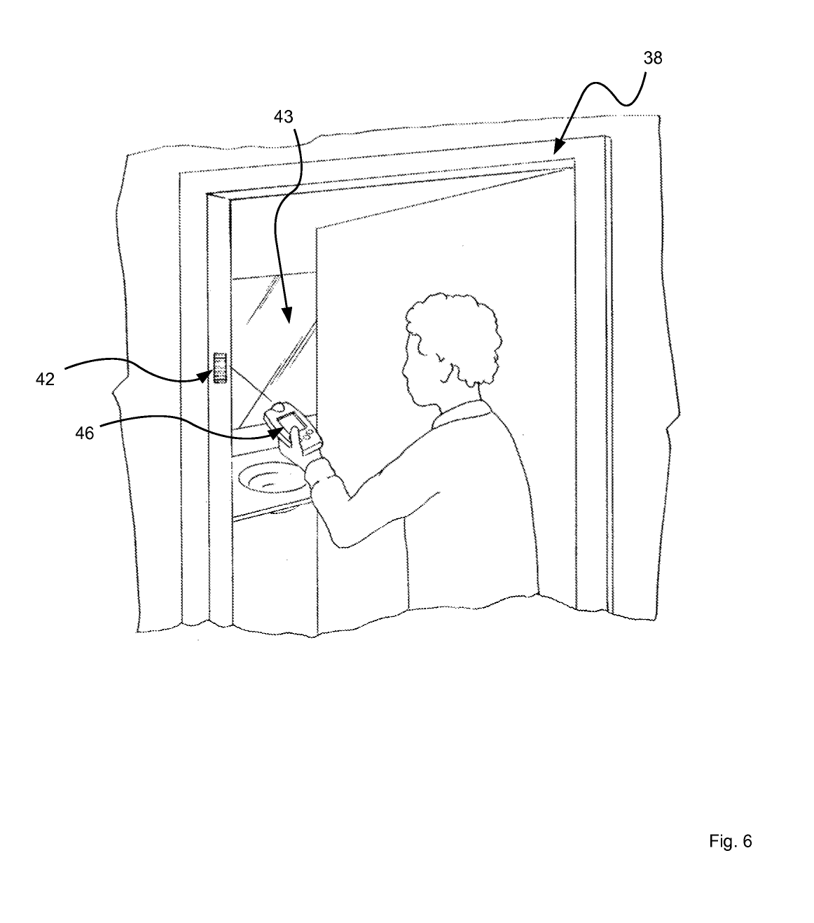

Referring now to FIG. 5, a method of diarizing janitorial services is indicated generally at 95. It is contemplated that the following discussion will assist in the foregoing understanding the functionality of PCD 46 when used during a janitorial patrol of facility 30. However, those of skill in the art will recognize that the operation and sequence of steps of method 95 can be varied, and need not actually be implemented on a system identical to PCD 46 or in facility 30, and such variations are within the scope of the invention.

Commencing at step 100, a cleaning patrol is commenced. In the present embodiment, a janitor will collect the cleaning supplies and equipment needed onto cleaning a cart. The janitor will also collect PCD 46 and task list 70 and add those items to the cart. It will be assumed that the janitor is cleaning facility 30.

Next at step 110, the next zone for cleaning is determined. In the present embodiment, the janitor will use PCD 46 and identify him or herself by entering appropriate data into software executing on PCD 46. The janitor will also identify that facility 30 is being cleaned. PCD 46 will then access a table of data regarding the various zones and tasks that need to be cleaned in facility 30. Using that table of data, and/or a preprogrammed schedule for performing a janitorial patrol of facility 30, PCD 30 will then determine the initial zone to be cleaned and present that information to the janitor. As an example, it will be assumed that PCD 46 determines that men's restroom 34d is the first zone 34 to be cleaned, and that this information is presented to the janitor.

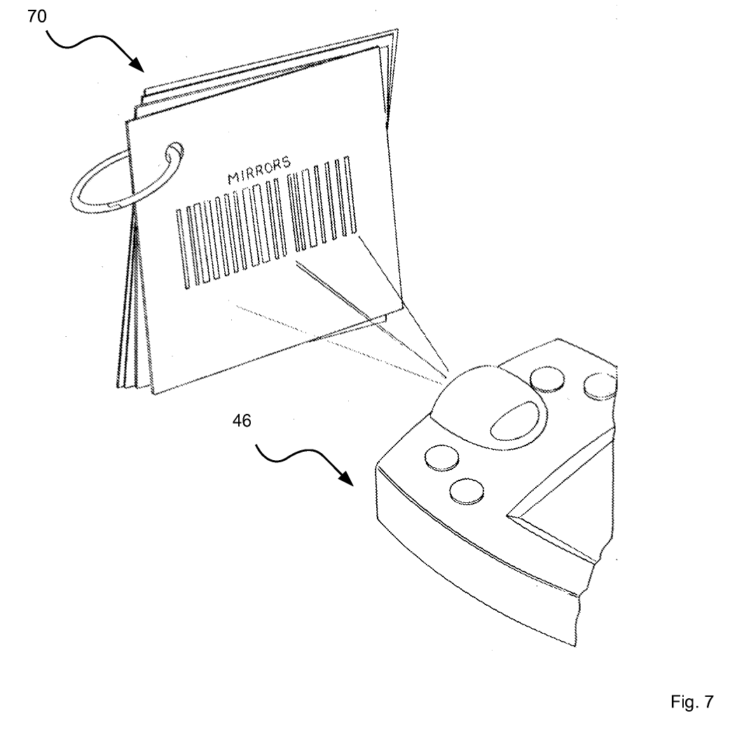

At step 120, PCD 46 will then sit in a “wait” state until it receives confirmation that the particular zone has been entered. In the present embodiment, PCD 46 will wait until a barcode 42 corresponding to the zone determined at step 110 is scanned. In the present example then, this wait state continues until the janitor reaches door 38 of men's restroom 34, and, as shown in FIG. 6, once the janitor scans barcode 42 located on the door frame of door 38, PCD 46 will confirm that “yes” entry to the zone determined at step 110 was entered, and the method will advance to step 130.

At step 130, the next task to be performed in the zone determined at step 110 will be determined. In the present embodiment, PCD 46 will then access a table of data regarding the various tasks that need to be cleaned in zone 34d of facility 30. Using that table of data, and/or a preprogrammed schedule for performing a janitorial patrol of facility 30, PCD 46 will then determine the initial task to be performed in zone 34 and present that information to the janitor. As an example, it will be assumed that PCD 30 determines that “Cleaning mirrors” is the first task to be performed in zone 34d, and that this information be presented to the janitor.

At step 140, PCD 46 will then sit in a “wait” state until it receives confirmation that a particular task has been completed. In the present embodiment, PCD 46 will wait until a card 74 from task list 70 and bearing a barcode corresponding to the task at step 120 is scanned. In the present example then, this wait state continues while the janitor performs the task of cleaning mirrors 43 of men's restroom 34. Once the task is completed, the janitor scans barcode 90 on the card 74 bearing the description 86 “Mirrors”. The performance of this scanning is represented in FIG. 7. At this point, PCD 46 will confirm that “yes”, the task has been completed and the method will advance to step 150.

At step 150, PCD 46 will determine if there are additional tasks to be performed. If, for example, PCD 46 contains a table that sink 43 is also to be cleaned, then at step 150, PCD 46 will determine “Yes”, further tasks are to be performed in zone 34d, and the method will return to step 130, where such other additional tasks will be determined, and thusly steps 130-150 will be repeated until it is determined at step 150 that “no”, there are no further additional tasks are to be performed and the method will advance to step 160.

By the same token, at step 160, PCD 46 will determine if there are additional zones to be cleaned. If, for example, PCD 46 contains a table that women's restroom 34c is also to be cleaned as part of this particular cleaning patrol, then at step 1650, PCD 46 will determine “Yes”, further tasks are to be performed in facility 30, and the method will return to step 110, where such other additional zones will be determined, and thusly steps 110-160 will be repeated until it is determined at step 150 that “no”, there are no further additional zones 34 to be cleaned and the method will advance to step 170.

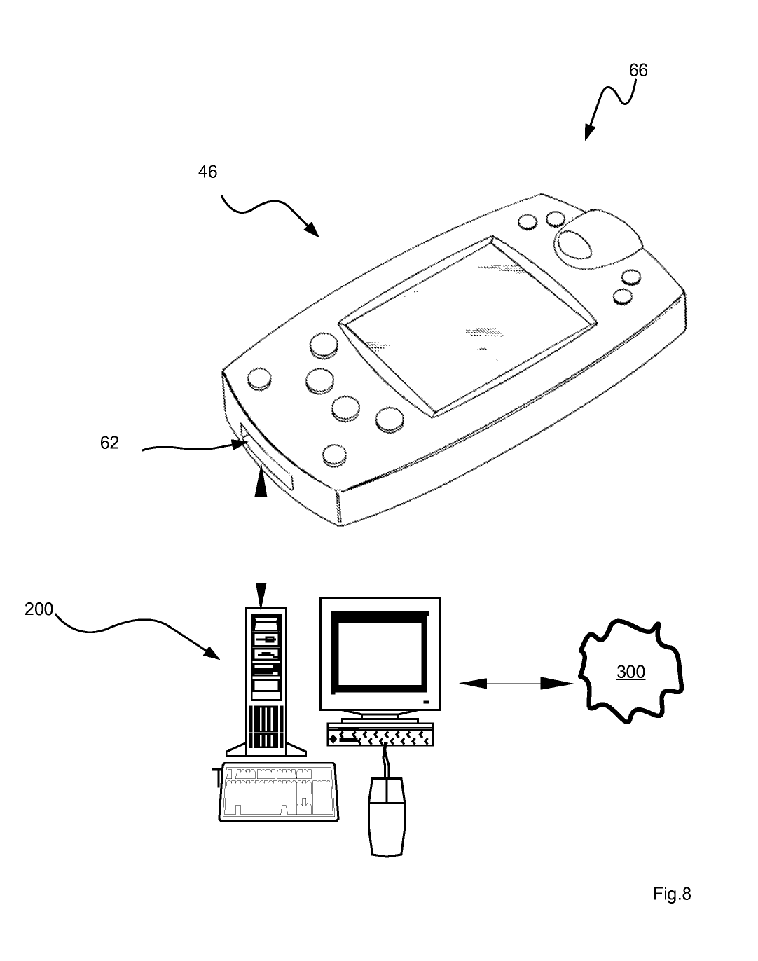

At step 170, a cleaning patrol report is uploaded to another computing device for storage and/or review. As shown in FIG. 8, PCD 46 is connected to a host computer 200 via docking port 62. It will thus be apparent that the medium for docking port 62's connection to computer 200 is not particularly limited, and can be based on RS232, USB, Infra-red or the like. Thus, the particulars of the cleaning patrol performed at steps 110-160 will thus be uploaded to computer 200. Such particulars may also include the exact times that scans of barcodes, such as barcodes 42 and/or 90 were effected, and thereby provide statistical information as to the times needed or consumed to perform a particular patrol.

In turn, computer 200 is connected to a local area network and/or a wide area network 300, such as the internet, and such connectivity can be used to present reports of uploaded data in web (or another) format to any interested party. Of particular interest, where cleaning patrols are performed by employees of a service company under contract with facility 30, then such web-based reports can provide substantially real-time confirmation that the cleaning services are actually being performed.

The method then advances to step 180, at which point the cleaning patrol ends.

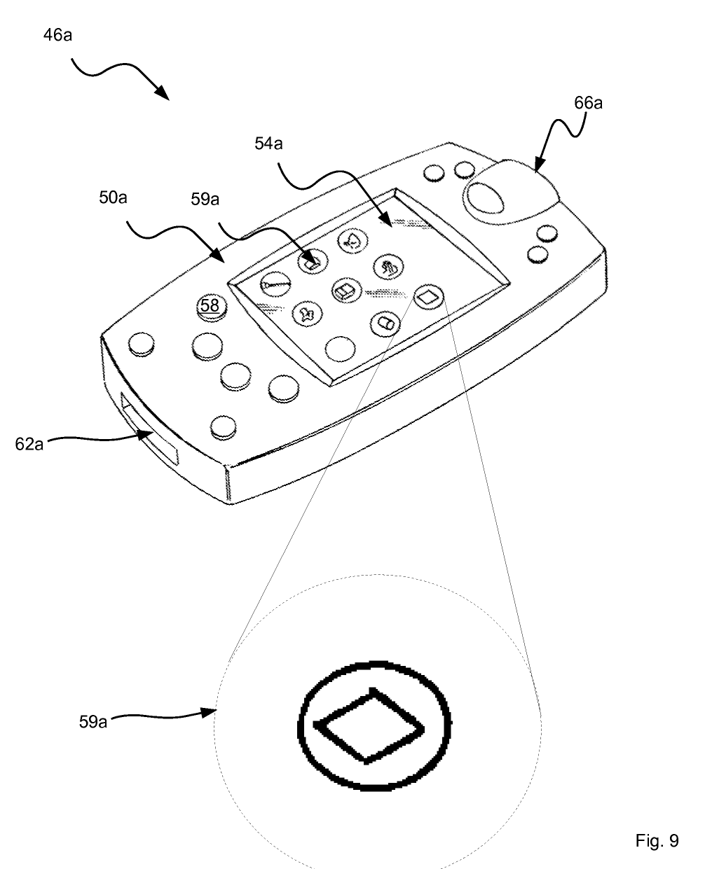

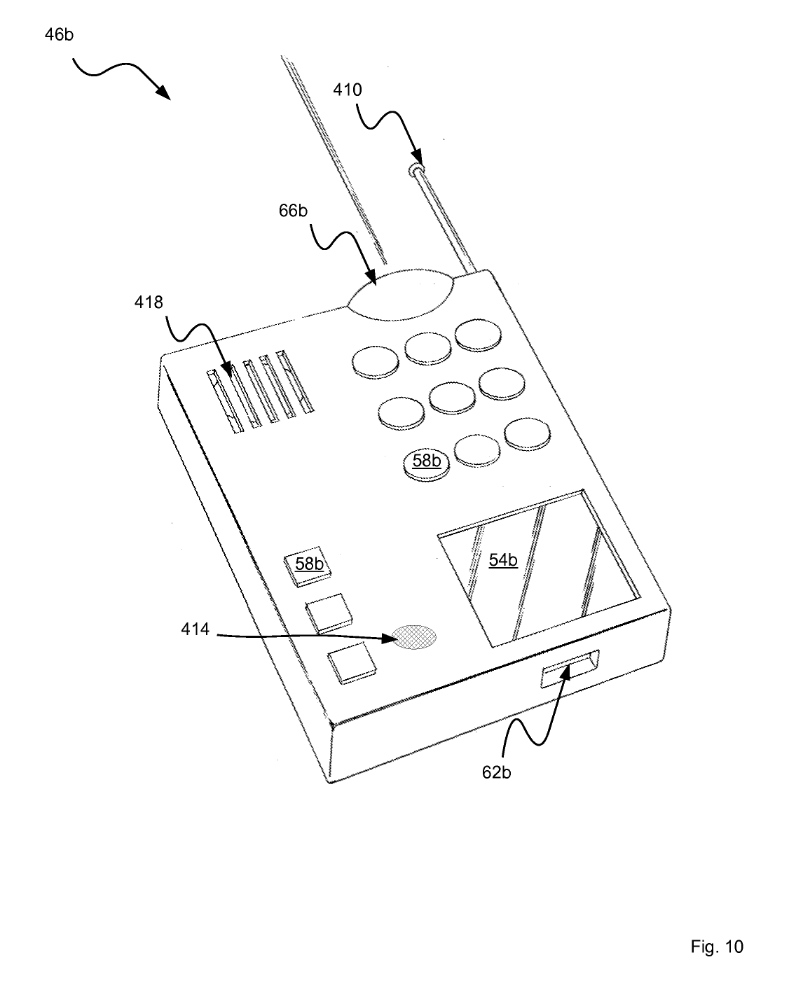

Referring now to FIG. 9, a portable computing device (“PCD”) in accordance with another embodiment of the invention is indicated generally at 46a. PCD 46a is thus substantially the same as PCD 46, except in this embodiment, PCD 46 is programmed to include at least one screen that includes a number of softkeys 59a that appear on a touch-screen display 54a. Each softkey 59a (not all of which are marked with reference 59a in FIG. 8) includes an icon that represents a particular task. FIG. 8 shows one icon of a softkey 59a that has been enlarged. The enlarged icon shows a rectangle, which is representative of mirrors 43. Thus, each softkey 59a represents one particular task, much in the same way that cards 74 each represent a task. In this embodiment, however, the need for cards 74 is obviated, as the task list is now presented in soft form directly to the janitor using PCD 46. Thus, when a task has been completed, the janitor simply pushes the icon and the corresponding softkey 59a is thereby activated. Using this embodiment, a variation of how to perform step 140 of method 95 is thus illustrated.

Referring now to FIG. 10, a portable computing device (“PCD”) in accordance with another embodiment of the invention is indicated generally at 46b. PCD 46b includes at least the same set of features as PCD 46, including a display 54b, a plurality of keys 58b, docking port 62b, and a barcode scanner 66b. PCD 46b also includes modem and a radio (not shown) connected to an external antenna 410 to provide PCD 46b with the capacity to communicate over radio-frequencies, using a proprietary standard or a public standard such as 802.11b, Bluetooth, or the like. The modem and radio in PCD 46b can also be based on wider area technologies, such as cellular telephone technologies like GSM (including GPRS), or CDMA. PCD 46d is thus operable to dynamically upload data to a host computer, such as host computer 200, where the host computer is equipped with a corresponding modem and radio. PCD 46b can also be operable to download new cleaning schedules of various zones and/or tasks to be performed.

PCD 46b also includes voice-recording capability, implemented with a microphone 414 and speaker 418. Microphone 414 and speaker 418 can thus allow the janitor to record comments and/or notes about particular tasks when they are performed. Such comments can also include, for example, information about items that need to be repaired by maintenance crews at a later date. The comments can be digitized in a voice file that are uploaded when a particular task is complete (via wireless), or when a zone is complete (via wireless) or when a entire patrol is complete (via wireless, or by returning to a central location where a docking station is available.) In general, microphone 414 and speaker 418 can be used as an input/output device alternate or supplementary to keys 58b and display 54b. It will now be understood that a cellular phone could be modified to provide the functionality of PCD 46b.

While only specific combinations of the various features and components of the present invention have been discussed herein, it will be apparent to those of skill in the art that desired subsets of the disclosed features and components and/or alternative combinations of these features and components can be utilized, as desired. For example, while each door of facility 30 is referred to above as only having one barcode affixed thereto that is respective to a particular zone 34, it is to be understood that where a door connects zones 34 that are part of a cleaning patrol, then a barcode for each zone 34 being connected by that door can be affixed on either side of the door.

Also, while the embodiments herein show barcodes for each zone 34 being affixed to a wall, and task lists being carried, it is to be understood that tasks could also be affixed to a wall proximal to where the task is to be performed. Or, a list of zones can be used (instead of affixing the zone identification to the wall), similar to task list 70, which could be scanned by the janitor as various zones are entered or exited, as desired.

Additionally, while method 95 shows the steps of determining the next zone for cleaning, and waiting until confirmation of that zone is received, (steps 110, 120), it is to be understood that these steps can be varied so that the janitor picks his or her own order of cleaning certain zones, and/or omitting various zones as they may see fit. Similarly, method 95 can be modified to allow the janitor to elect to skip certain zones and/or tasks, with the additional option of entering in comments as to why or why not a particular zone was skipped. Overall, method 95 can be modified to eliminate or override automatic scheduling, allowing the janitor to simply clean zones and/or perform tasks within those zones on an ad hoc basis, according to the janitor's own preferred sequence or schedule for cleaning the facility.

Additionally, while description 86 is shown in text on card 86 in FIG. 4, it can be preferred to use icons or pictograms for ease of flipping through cards 74 and/or to eliminate or reduce language barriers and/or differences that may exist between different cleaners who may be assigned to perform the same patrol during different shifts or times.

While the embodiments discussed herein refer to barcodes, it is to be understood that other types of machine readable indicia and/or mediums can be used. For example, instead of barcodes, radio frequency tags (“RF tags”) could be used and corresponding functionality added to the portable computing device or other equipment being used by janitors and cleaners to read such RF tags.

The above-described embodiments of the invention are intended to be examples of the present invention and alterations and modifications may be effected thereto, by those of skill in the art, without departing from the scope of the invention which is defined solely by the claims appended hereto.

1-38. (canceled)

39. A system for diarizing janitorial services during a janitorial cleaning patrol by a janitorial cleaning personnel along a janitorial cleaning patrol route that includes at least one janitorial cleaning zone of a facility, said system comprising:
at least one first printed barcode adapted to identify said janitorial cleaning personnel (“user barcode”);
at least one second printed barcode mounted substantially local to said facility (“facility barcode”);
at least one third printed barcode mounted substantially local to one said janitorial cleaning zone (“zone barcode”);
at least one fourth printed barcode representative of a prescribed janitorial cleaning task to be performed at said janitorial cleaning zone (“task barcode”);
a portable unit adapted to be carried by said janitorial cleaning personnel, said portable unit including an outer casing that frames a display, a plurality of keys, a docking port, a barcode reader, a clock, memory, and computing hardware interconnecting said display, said keys, said docking port, said clock, said memory and said barcode reader;
wherein said barcode reader operatively scans said user barcode, said facility barcode substantially contemporaneously with the arrival of said janitorial cleaning personnel at said facility, said zone barcode substantially contemporaneously with the arrival of said janitorial cleaning personnel at said janitorial cleaning zone, and said task barcode substantially contemporaneous with the performance of said prescribed janitorial cleaning task; and wherein said computing hardware operatively records a log of said scans and the time of each said scan.

40. The system according to claim 39 wherein said computing hardware operatively presents, on said display, at least one display member selected from the display group consisting of: (a) said at least one cleaning zone, prior to said cleaning of each said zone; and (b) said prescribed janitorial cleaning task, prior to said performance of each said prescribed janitorial cleaning task in one said zone.

41. The system according to claim 39, further comprising at least a second zone barcode mounted substantially local to another one said cleaning zone of said cleaning patrol route.

42. The system of claim 39 additionally comprising a microphone and wherein said computing hardware also operatively records a comment of said janitorial cleaning personnel that is associated with said completion of said janitorial cleaning of each said zone.

43. The system of claim 39 wherein said output device is a wireless transmitter operatively transmitting said completion of said janitorial cleaning of each said zone to a wireless receiver.

44. The system of claim 39 wherein said output device is a computer display operatively presenting said completion of said janitorial cleaning of each said zone to said janitorial cleaning personnel.

45. The system of claim 39 wherein said output device is a docking port that operatively connects said portable unit to an external computer, and wherein said external computer operatively receives said completion of said janitorial cleaning of each said zone from said docking port.

46. The system of claim 39, further including a wireless communication system operatively connecting said computing hardware with a host server and uploading to said host server a time when each said completion of said janitorial cleaning of each said zone occurred.

47. The system of claim 46, wherein said uploading occurs each time said computing hardware records one said completion of said janitorial cleaning of each said zone.

48. A method of diarizing the performance of janitorial services during a patrol by janitorial cleaning personnel along a janitorial cleaning patrol route that includes at least one prescribed janitorial cleaning task in at least one janitorial cleaning zone of a facility, said method comprising the steps of:
i. providing said janitorial cleaning personnel with a first printed barcode adapted to identify said janitorial cleaning personnel (“user barcode”);
ii. said janitorial cleaning personnel scanning said user barcode and obtaining facility, zone and task information;
iii. providing at least one second printed barcode mounted substantially local to said facility (“facility barcode”);
iv. said janitorial cleaning personnel scanning said facility barcode substantially contemporaneously with the arrival of said janitorial cleaning personnel at said facility;
v. providing at least one third printed barcode mounted substantially local to one said janitorial cleaning zone (“zone barcode”);
vi. said janitorial cleaning personnel scanning said zone barcode substantially contemporaneously with the arrival of said janitorial cleaning personnel at said janitorial cleaning zone;
vii. providing at least one fourth printed barcode representative of a prescribed janitorial cleaning task to be performed at said janitorial cleaning zone (“task barcode”);
viii. said janitorial cleaning personnel scanning said task barcode substantially contemporaneous with the performance of said prescribed janitorial cleaning task;
ix. determining whether a next one said prescribed janitorial cleaning task remains to be performed in said one said janitorial cleaning zone;
x. repeating steps vii-ix until no prescribed janitorial cleaning task remains to be completed in said one said janitorial cleaning zone;
xi. determining whether a next one said janitorial cleaning zone remains to be cleaned;
xii. repeating steps v-x until no prescribed janitorial cleaning zone remains to be cleaned;

49. The method according to claim 48 further comprising the steps of:
a recording step of recording a time when each said scan occurs according to step (ii), (iv), (vi) and (viii); and
an uploading step of uploading said time to a host computer.

50. The method according to claim 49, wherein said uploading step occurs in real-time substantially contemporaneous with each said time.

51. The method according to claim 48, wherein the services are non-janitorial repetitive patrol services.

52. The method according to claim 49, wherein the services are non-janitorial repetitive patrol services.

53. The method according to claim 50, wherein the services are non-janitorial repetitive patrol services.
